(19) United States
(12) Patent Application Publication
(10) Pub. No.: US 2025/0109245 A1
(43) Pub. Date: Apr. 3, 2025

(54) PREPARATION OF UNSATURATED POLYESTERS

(71) Applicant: Eastman Chemical Company, Kingsport, TN (US)

(72) Inventors: Hongkun He, Kingsport, TN (US); Jeffery Earl Grant Powell, Blountville, TN (US); Katelyn Rose Houston, Johnson City, TN (US)

(73) Assignee: Eastman Chemical Company, Kingsport, TN (US)

(21) Appl. No.: 18/833,006

(22) PCT Filed: Jan. 25, 2023
(86) PCT No.: PCT/US2023/061219

§ 371 Date: Jul. 25, 2024

Related U.S. Application Data
(60) Provisional application No. 63/267,345, filed on Jan. 31, 2022.

(51) Int. Cl. C08G 63/87; C08G 63/52; C08G 63/91; C09D 167/06

(52) U.S. Cl. CPC C08G 63/87; C08G 63/52; C08G 63/918; C09D 167/06; C08G 2150/00

(57) ABSTRACT

The present invention relates to a process for making unsaturated polyester with high fumarate/maleate ratio. In particular, the process comprises making unsaturated polyester with ethylenically unsaturated compound as one of the starting material followed by isomerization using N,N-dimethylacetoacetamide (DMAA) as the catalyst. The polyester has a fumarate/maleate ratio of 90/10 or greater.

### FIELD OF THE INVENTION

The present invention relates to a process for making unsaturated polyester with high fumarate/maleate ratio. In particular, the process comprises making unsaturated polyester with an ethylenically unsaturated compound as one of the starting materials followed by isomerization using N,N-dimethylacetoacetamide (DMAA) as the catalyst. The polyester has a fumarate/maleate ratio of 90/10 or greater.

### BACKGROUND OF THE INVENTION

Unsaturated polyesters are a class of condensation polymers commonly produced by a condensation reaction between glycols and unsaturated diacids. The unsaturated diacids contain carbon-carbon double bonds which act as reactive olefinic sites on the polyester backbone. In the synthesis of unsaturated polyesters, saturated diacids are often used along with unsaturated diacids to adjust unsaturation content in the resins and tune the physical and mechanical properties of the resulting polyester. A two-stage reaction is usually conducted to make unsaturated polyesters. The saturated diacids first react with a stoichiometric excess of glycols to form hydroxyl terminated oligomers, which then react with unsaturated diacids in the second stage. The most widely used unsaturated diacids include maleic anhydride, maleic acid, and fumaric acid.

The reactive unsaturation of unsaturated polyesters can be crosslinked with ethylenic monomers such as styrene to form thermosetting crosslinked polymers, or grafted with ethylenic monomers such as acrylates to form acrylic modified polyesters. Fumarate unsaturation is more reactive than maleate unsaturation in radical reactions with ethylenically unsaturated monomers. Therefore, fumarate isomer is desired for many applications where high conversion of unsaturation, fast cure, or superior end use properties are needed. Nevertheless, fumaric acid is seldom used in production of unsaturated polyesters because it is more expensive and reacts with glycols more slowly than maleic anhydride, which result in increased production cost. As a result, the majority of the world production of maleic anhydride is used commercially as the starting materials for the production of unsaturated polyesters.

It is valuable to increase the content of fumarate isomers in the unsaturation of the final products during the production of unsaturated polyesters with maleic anhydride as the raw material. The isomerization of maleate to fumarate is favored by higher reaction temperature and longer reaction time because fumarate is thermodynamically more stable than maleate.

It is known that the fumarate/maleate ratios of technical products typically range from 40/60 to 70/30. [See Kricheldorf, Hans. (2013). Polycondensation: History and New Results. 10.1007/978-3-642-39429-4]. High amounts of isomerization can be achieved when secondary glycols such as propylene glycol are used in the production of unsaturated polyester instead of primary glycols. [See L. G. Curtis, D. L. Edwards, R. M. Simons, P. J. Trent and P. T. Von Bramer. Ind. Eng. Chem. Prod. Res. Dev. 1964, 3, 3, 218-221. Investigation of Maleate-Fumarate Isomerization in Unsaturated Polyesters by Nuclear Magnetic Resonance]. In addition, process improvements have been shown to achieve higher amounts of isomerization when 2-methyl-1,3-propanediol (MPD) is used as one of the monomers for making unsaturated polyesters [see U.S. Pat. No. 6,555,623 B1]. However, these methods are only applicable to unsaturated polyesters made with specific monomer compositions and/or reaction conditions. Isomerization catalysts, such as morpholine and diethylamine, have been used for the preparation of a polyester predominating in fumarate esters by isomerization of maleate polyester [see U.S. Pat. No. 3,576,909]. The amine moieties in these isomerization catalysts may cause side reactions when the polyester resins are subjected to further chemical reactions and used for coating applications. The residual isomerization catalysts in the polyester resins could be a regulatory concern when they are used for food contact applications.

This invention describes the use of N,N-dimethylacetoacetamide (DMAA) as catalyst for the isomerization of unsaturated polyesters prepared by using an ethylenically unsaturated compound as the double bond source. DMAA is commonly used as a general-purpose low color-generating copromoter for many unsaturated polyester resin formulations. For example, the ambient temperature cure unsaturated polyester thermoset resin systems require free-radical sources, with the most common being methyl ethyl ketone peroxide (MEKP), and a cobalt salt generally known as the promoter. Co-promoters, such as DMAA, are used to further accelerate cure by interaction with the cobalt salt making it more effective at decomposing the organic peroxide. [See J. E. Powell and A. H. Honeycutt, Composites Research Journal, 2008, 2, 2, 34-42. Reactive Copromoter for Unsaturated Polyester Resins]. DMAA can be used in composite counter tops that can have direct food contact.

We have surprisingly found that DMAA performs significantly better than many other types of chemicals with similar structures at the same conditions and that a fumarate/maleate ratio of above 90/10, or above 95/5, or above 97/3 can be achieved. The isomerization of unsaturated polyesters with DMAA is conducted after polycondensation, which avoids exposing the catalyst to high temperature and long reaction time of polycondensation. This can result in fewer side reactions and better color of the resulting resins.

### SUMMARY OF THE INVENTION

In one embodiment of the invention, there is provided a process for the preparation of an unsaturated polyester comprising:
(a) synthesizing an unsaturated polyester resin having maleate isomer content by reacting a polyacid component and a polyol component, in the presence of a catalyst, wherein at least one of said polyacid and said polyol components is an ethylenically unsaturated compound; and
(b) converting maleate isomer to fumarate isomer in the unsaturated polyester resin of step a) by catalytic isomerization with N,N-dimethylacetoacetamide to a fumarate/maleate ratio of 90/10 or greater, or 95/5 or greater or 97/3 or greater.

In another embodiment, this invention provides a process for the preparation of an unsaturated polyester, comprising the residues of:
a. maleic anhydride,
b. a polycarboxylic acid component, a derivative of polycarboxylic acid compound other than maleic anhydride, or a combination thereof, and
c. a polyhydroxyl component;
   wherein said unsaturated polyester has a fumarate/maleate ratio of 90/10 or greater.

In another embodiment, the invention provides an unsaturated polyester comprising:
a. the residues of maleic anhydride in an amount ranging from about 0.5 to 90 mole %, based on the total moles of (a) and (b),
b. a polycarboxylic acid compound, a derivative of polycarboxylic acid compound other than maleic anhydride, or a combination thereof comprising;
   i. a dicarboxylic acid in an amount ranging from 10 to 99.5 mole %, based on the total moles of (bi) and (bii), and
   ii. a polycarboxylic acid anhydride in an amount ranging from 0 to 99.5 mole %, based on the total moles of (bi) and (bii), and
c. a polyhydroxyl component comprising:
   i. a diol in an amount ranging from 0 to 95 mole %, based on the total moles of (ci) and (cii), and
   ii. a triol or tetraol in an amount ranging from 0 to 20 mole %, based on the total moles of (a) and (b); and
wherein said unsaturated polyester has a fumarate/maleate ratio of 90/10 or greater.

In one or more embodiments herein, the fumarate/maleate ratio is 95/5 or greater fumarate, or alternatively, the fumarate/maleate ratio is 97/3 or greater fumarate.

In one or more embodiments herein, the ethylenically unsaturated compound comprises one or more of the following: maleic anhydride/acid, dialkyl maleate, monoalkyl maleate, citraconic anhydride/acid, 2,3-dimethylmaleic anhydride/acid, 2-tert-butylmaleic anhydride/acid, phenylmaleic anhydride/acid.

In one or more embodiments herein, the polyacid component of step (a) comprises one or more of the following: isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, 2,6-naphthalenedicarboxylic acid, glutaric acid, itaconic acid, and their derivatives, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid. nadic acid, hexahydrophthalic acid, 2,5-bis(hydroxymethyl)furan, 2,5-furandicarboxylic acid.

In one or more embodiments herein, the polyacid component of step (a) comprises one or more of the following: isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, adipic acid, hexahydrophthalic anhydride, tetrahydrophthalic anhydride, trimellitic anhydride, maleic acid or anhydride, fumaric acid, succinic anhydride, and succinic acid.

In one or more embodiments herein, the polyol component of step (a) comprises one or more of the following: 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 1,7-heptanediol, 1,8-octanediol, 1,9-nonanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, polyethylene glycol, 1,1,1-trimethylol propane, 1,1,1-trimethylolethane, glycerin, pentaerythritol, erythritol, threitol, dipentaerythritol, sorbitol, glycerol, trimethylolethane, trimethylolpropane, pentaerythritol, 1,2,6-hexanetriol, 1,1,4,4-tetrakis(hydroxymethyl)cyclohexane, tris(hydroxyethyl)isocyanurate, tripentaerythritol, and dipentaerythritol. tripropylene glycol, hexylene glycol, 1,2-propanediol, 1,3-propanediol, butyl ethyl propanediol, 2-ethyl-1,4-butanediol, trimethyl pentanediol, 2-methylpentanediol, trimethylol butane, tricyclodecane dimethanol, 2-ethyl-2,4-dimethylhexane-1,3-diol, p-xylenediol, hydrogenated bisphenol A, bio-mass derived polyols, and oligomer molecules having a hydroxyl group at each end resulting from an alcoholysis reaction of collected waste polyethylene terephthalate by an aliphatic glycol.

In one or more embodiments herein, the polyol component of step (a) comprises one or more of the following: 2,2,4,4-tetramethyl-1,3-cyclobutanediol, 1,4-cyclohexane dimethanol, 1,3-cyclohexane dimethanol, neopentyl glycol, ethylene glycol, 2-methyl 1,3-propane diol, 1,6-hexanediol, trimethylol propane.

In one or more embodiments herein, step (a) is conducted under polycondensation conditions at a temperature of about 150 to 260° C.

In one or more embodiments herein, said catalyst of step (a) is a polycondensation catalyst in a concentration of about 0.01 to 1.00 weight percent, based on the amount of reactants.

In one or more embodiments herein, said N,N-dimethylacetoacetamide catalyst of step (b) comprises one or more of N,N-dimethylacetoacetamide without solvent, N,N-dimethylacetoacetamide in an aqueous solution, and N,N-dimethylacetoacetamide solution in an organic solvent. In some embodiments, the N,N-dimethylacetoacetamide aqueous solution has a N,N-dimethylacetoacetamide weight content above 1%. In some embodiments, the N,N-dimethylacetoacetamide solution in organic solvent has a N,N-dimethylacetoacetamide weight content above 1%.

In one or more embodiments herein, the amount of the added dimethylacetoacetamide catalyst in step (b) ranges from 0.01 to 1000 parts by weight. Alternatively, in one or more embodiments herein, the amount of the added dimethylacetoacetamide catalyst in step (b) ranges from 0.1 to 100 parts, from 0.5 to 50 parts, or from 1 to 10 parts.

In one or more embodiments herein, the temperature for the isomerization in step (b) ranges from 50 to 250° C., from 80 to 220° C., from 100 to 200° C., or from 150 to 180° C.

In one or more embodiments herein, the isomerization in step (b) is conducted for a period of 5 minutes to 120 hours, 30 minutes to 48 hours, 1 to 12 hours, or 2 to 6 hours.

### DETAILED DESCRIPTION

In this specification and in the claims that follow, reference will be made to a number of terms, which shall be defined to have the following meanings.

“Alcohol” means a chemical containing one or more hydroxyl groups.

“Aldehyde” means a chemical containing one or more —C(O)H groups.

“Aliphatic” means a compound having a non-aromatic structure.

“Diacid” means a compound having two carboxyl functional groups.

“Diamine” means a compound containing two amino groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C; or a combination of A and B, A and C, B and C, or A, B, and C.

As used herein numerical ranges are intended to include the beginning number in the range and the ending number in the range and all numerical values and ranges in between the beginning and ending range numbers. For example, the range 40° C. to 60° C. includes the ranges 40° C. to 59° C., 41° C. to 60° C., 41.5° C. to 55.75° C. and 40°, 41°, 42°, 43°, etc. through 60° C.

The term “residue,” as used herein in reference to the polymers of the invention, means any organic structure incorporated into a polymer through a polycondensation or ring opening reaction involving the corresponding monomer. It will also be understood by persons having ordinary skill in the art, that the residues associated within the various curable polyesters of the invention can be derived from the parent monomer compound itself or any derivative of the parent compound. For example, the dicarboxylic acid residues referred to in the polymers of the invention may be derived from a dicarboxylic acid monomer or its associated acid halides, esters, salts, anhydrides, or mixtures thereof. Thus, as used herein, the term “dicarboxylic acid” is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a curable, aliphatic polyester.

This invention describes the use of N,N-dimethylacetoacetamide (DMAA) as catalyst for the isomerization of unsaturated polyesters prepared by using an ethylenically unsaturated compound as the double bond source.

The present inventors have surprisingly found that DMAA perform significantly better than many other types of chemicals with similar structures at the same conditions and a fumarate/maleate ratio of above 90/10, or above 95/5, or above 97/3 can be achieved. The isomerization of unsaturated polyesters with DMAA is conducted after polycondensation, which avoids exposing the catalyst to high temperature and long reaction time of polycondensation. This can result in fewer side reactions and better color of the resulting resins.

In one embodiment, this invention provides a process for the preparation of an unsaturated polyester, comprising the residues of
a) an ethylenically unsaturated monomer reactant,
b) a polycarboxylic acid component, a derivative of polycarboxylic acid compound other than maleic anhydride, or a combination thereof, and
c) a polyhydroxyl component;
wherein said unsaturated polyester has a fumarate/maleate ratio of 90/10 or greater.

The ethylenically unsaturated monomer reactant of (a) is preferably a difunctional monomer, more preferably a diacid or anhydride monomer. Suitable examples of this ethylenically unsaturated monomer reactant of (a) include maleic anhydride, maleic acid, fumaric acid, itaconic acid, itaconic anhydride, tetrahydrophthalic anhydride, crotonic acid, crotonic anhydride, acrylic acid, methacrylic acid, 2-hydroxyethyl (meth)acrylate, 2-hydroxypropyl
(meth)acrylate, and glycidyl methacrylate, with maleic anhydride being most preferred.

Suitable polycarboxylic acid compounds (b) include compounds having at least two carboxylic acid groups. In one aspect, the polycarboxylic acid compound comprises a dicaraboxylic acid compound having two carboxylic acid groups, derivatives thereof, or combinations thereof, capable of forming an ester linkage with a polyhydroxyl component. For example, a polyester can be synthesized by using a polyhydroxyl compound and a derivative of a dicarboxylic acid such as, for example, dimethyl ester or other dialkyl esters of the diacid, or diacid chloride or other diacid halides, or acid anhydride.

Examples of dicarboxylic acids that may be used include aliphatic dicarboxylic acids, alicyclic dicarboxylic acids, aromatic dicarboxylic acids, derivatives of each, or mixtures of two or more of these acids. Thus, suitable dicarboxylic acids include, but are not limited to, isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, 2,6-naphthalenedicarboxylic acid, glutaric acid, itaconic acid, and their derivatives, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, and mixtures thereof.

In another aspect, the polycarboxylic acid component (b) comprises a tricarboxylic acid or anhydride, for example, trimellitic acid and trimellitic anhydride.

In another embodiment of the invention the polycarboxylic acid component (b) comprises isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, adipic acid, 2,6-naphthalenedicarboxylic acid, 1,4-naphthalenedicarboxylic acid; 2,5-naphthalenedicarboxylic acid; hexahydrophthalic anhydride, tetrahydrophthalic anhydride, trimellitic anhydride, maleic acid or anhydride, fumaric acid, succinic anhydride, and succinic acid. Most preferably, the polycarboxylic acid component (b) is selected from the group consisting of isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, adipic acid, hexahydrophthalic anhydride, trimellitic anhydride, maleic anhydride, and succinic anhydride.

Suitable polyhydroxyl compounds (c) include compounds having at least two hydroxyl groups. Examples of such compounds include 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, hydrogenated bisphenol A, ethylene glycol, propylene glycol, diethylene glycol, dipropylene glycol, triethylene glycol, tetraethylene glycol, polyethylene glycol, 1,1,1-trimethylol propane, 1,1,1-trimethylolethane, glycerin, pentaerythritol, erythritol, threitol, dipentaerythritol, sorbitol, and the like. Preferably, the polyhydroxyl compound (b) comprises 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, 1,6-hexanediol, 1,1,1-trimethylol propane, 1,1,1-trimethylolethane, glycerin, and pentaerythritol.

In some embodiments the polyhydroxy compound (b) is selected from the group consisting of 2,2-dimethyl-1,3-propanediol (neopentyl glycol or NPG), 1,3-cyclohexanedimethanol, 1,4-cyclohexanedimethanol, 2-methyl-1,3-propanediol, 1,1,1-trimethylol propane, 1,1,1-trimethylolethane, glycerin, and pentaerythritol.

In some embodiments the polyhydroxy compound (b) is a 2,2,4,4-tetraalkylcyclobutane-1,3-diol compound. Such a compound can be represented by the general structure:

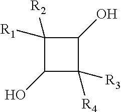

wherein R1, R2, R3, and R4 each independently represent an alkyl radical, for example, a lower alkyl radical having 1 to 8 carbon atoms. The alkyl radicals may be linear, branched, or a combination of linear and branched alkyl radicals.

The alkyl radicals R1, R2, R3, and R4 on the 2,2,4,4-tetraalkylcyclobutane-1,3-dione may each independently have 1 to 8 carbon atoms. 2,2,4,4-tetraalkylcyclobutane-1,3-diones that are suitably reduced to the corresponding diols include, but are not limited to, 2,2,4,4-tetramethylcyclobutane-1,3-dione, 2,2,4,4-tetraethylcyclobutane-1,3-dione, 2,2,4,4-tetra-n-propylcyclobutane-1,3-dione, 2,2,4,4-tetra-n-butylcyclobutane-1,3-dione, 2,2,4,4-tetra-n-pentylcyclobutane-1,3-dione, 2,2,4,4-tetra-n-hexylcyclobutane-1,3-dione, 2,2,4,4-tetra-n-heptylcyclobutane-1,3-dione, 2,2,4,4-tetra-n-octylcyclobutane-1,3-dione, 2,2-dimethyl-4,4-diethylcyclobutane-1,3-dione, 2-ethyl-2,4,4-trimethylcyclobutane-1,3-dione, 2,4-dimethyl-2,4-diethyl-cyclobutane-1,3-dione, 2,4-dimethyl-2,4-di-n-propylcyclobutane-1,3-dione, 2,4-n-dibutyl-2,4-diethylcyclobutane-1,3-dione, 2,4-dimethyl-2,4-diisobutylcyclobutane-1,3-dione, and 2,4-diethyl-2,4-diisoamylcyclobutane-1,3-dione.

The corresponding 2,2,4,4-tetraalkylcyclobutane-1,3-diols that may be used include 2,2,4,4-tetramethylcyclobutane-1,3-diol, 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol.

In some embodiments of this invention the polyhydroxy compound (b) is 2,2,4,4-tetramethylcyclobutane-1,3-diol.

The unsaturated polyester of this invention has an acid number ranging from about 0 to about 200 mgKOH/g and a hydroxyl number ranging from about 0 to about 200 mgKOH/g. The preferred acid number and hydroxyl number may vary depending on the application. For example, the desirable acid number for waterborne coating application is about 50 to about 100 to impart sufficient water dispersibility after neutralization, whereas the preferred acid number for solvent-based coating application is about 20 to about 50 for better solubility and lower solution viscosity. The desirable hydroxyl number is about 50 to about 100 for crosslinking with hydroxyl-active crosslinkers such as, for example, amino resin (or aminoplast) and isocyanate resin. For dual crosslinking system, for example, a coating formulation containing both amino and epoxy crosslinkers, the desirable hydroxyl number is 20 to 60 and acid number is 20 to 50.

The glass transition temperature (Tg) of the unsaturated polyester of the present invention may be from −20° C. to 120° C., from 10° C. to 100° C., from 20° C. to 90° C., from 30° C. to 80° C., or from 40° C. to 70° C.

The weight average molecular weight (Mw) of the unsaturated polyester of the present invention may be from 500 to 100,000; from 1,000 to 50,000; from 2,000 to 10,000; or from 3,000 to 5,000 g/mole.

In another embodiment, there is provided an unsaturated polyester, comprising:
(a) the residues of maleic anhydride in an amount ranging from about 0.5 to 90 mole %, based on the total moles of (a) and (b),
(b) a polycarboxylic acid compound, a derivative of polycarboxylic acid compound other than maleic anhydride, or a combination thereof comprising;
   (i) a dicarboxylic acid in an amount ranging from 10 to 99.5 mole %, based on the total moles of (bi) and (bii), and
   (ii) a polycarboxylic acid anhydride in an amount ranging from 0 to 99.5 mole %, based on the total moles of (bi) and (bii), and
(c) a polyhydroxyl component comprising:
   (i) a diol in an amount ranging from 0 to 95 mole %, based on the total moles of (ci) and (cii), and
   (ii) a triol or tetraol in an amount ranging from 0 to 20 mole %, based on the total moles of (a) and (b); and
wherein said unsaturated polyester has a fumarate/maleate ratio of 90/10 or greater.

In some embodiments of the invention, the diol (c)(i) is selected from the group consisting of 2,2-dimethyl-1,3-propanediol (neopentyl glycol), 1,3-cyclohexanedimethanol, 1,4-cyclohexanedimethanol, and 2-methyl-1,3-propanediol; the triol or tetraol (b)(ii) is selected from the group consisting of 1,1,1-trimethylol propane, 1,1,1-trimethylolethane, glycerin, and pentaerythritol; the dicarboxylic acid (c)(i) is selected from the group consisting of isophthalic acid (or dimethyl isophthalate), terephthalic acid (or dimethyl terephthalate), 1,4-cyclohexanedicarboxylic acid, 1,3-cyclohexanedicarboxylic acid, and adipic acid; and the polycarboxylic acid anhydride (c)(ii) is selected from the group consisting of trimellitic anhydride, hexahydrophthalic anhydride, maleic anhydride, and succinic anhydride.

In yet another embodiment, there is provided a method for the preparation of the above unsaturated polyester, comprising the steps of (1) producing an unsaturated polyester using polyacid and polyol components under polycondensation conditions with maleic anhydride as one of the components; and (2) converting maleate isomer to fumarate isomer in the unsaturated polyester made in step (1) by catalytic isomerization with DMAA to a fumarate/maleate ratio of 90/10 or greater; wherein step (1) is conducted under polycondensation conditions at a temperature of about 150 to 260° C., and the catalyst used in step (1) is a polycondensation catalyst in a concentration of about 0.01 to 1.00 weight percent, based on the amount of reactants.

Catalysts are used to accelerate the rate of the polycondensation reaction. The catalyst may be any food grade catalyst known in the art for the formation of a polyester resins. For example, FASCAT® 9100 (monobutyltin oxide) and FASCAT® 9102 (monobutyltin tris(2-ethylhexanoate)) available from PMC Organometallix and CYCAT® XK 406 N (a phosphoric acid derivative) available from Allnex Belgium SA may be used in this invention. The amount of catalyst may be determined by routine experimentation as understood by those skilled in the art. Preferably, a catalyst is added in amounts ranging from about 0.01 to about 1.00 weight percent, based on the amount of reactants.

The catalyst for the polycondensation reaction is preferably an acid catalyst more preferably an organo-metallic compound, such as a tin or titanium containing compound. Suitable examples of the acid catalyst include dibutyltin oxide, stannous oxalate, titanium tetraisopropoxide, butylstannonic acid, and p-toluenesulfonic acid, with butylstannoic acid being most preferred. A preferred butylstannoic acid catalyst is Fascat 4100 from ATOCHEM USA Inc. The catalytic amount is about 0 to 0.5 weight percent, based on the total weight of reactants, preferably about 0.01 to 0.2 weight percent, with about 0.1 weight percent being most preferred.

The DMAA used in step (2) comprises one or more of the following: (a) pure DMAA without solvent, (b) DMAA aqueous solution, and (c) DMAA solution in organic solvent. The DMAA aqueous solution has a DMAA weight content above 1%, such as above 10%, or suitably above 50%, or even above 70%. The DMAA solution in organic solvent has a DMAA weight content above 1%, such as above 10%, or suitably above 50%, or even above 70%.

The amount of the added DMAA in step (2) ranges from 0.01 to 1000 parts by weight based on 100 parts by weight of the maleate, such as from 0.1 to 100 parts, or suitably from 0.5 to 50 parts, or even from 1 to 10 parts.

The temperature for the isomerization in step (2) ranges from about 50 to 250° C., such as from 80 to 220° C., or suitably from 100 to 200° C., or even from 150 to 180° C.

The isomerization in step (2) is conducted for a period from about 5 minutes to 120 hours, such as from 30 minutes to 48 hours, or suitably from 1 to 12 hours, or even from 2 to 6 hours.

Thus, the unsaturated polyester prepared by the method provided this invention can be further used in a curable coating composition comprising:
(a) an unsaturated polyester of the present invention and
(b) a crosslinker selected from the group comprising amino resin, blocked isocyanate resin, phenolic resins, epoxy resin, and epoxidized phenolic resin.

The amino resin crosslinker (or cross-linking agent) is preferably a melamine-formaldehyde type crosslinking agent, i.e., a cross-linking agent having a plurality of —N(CH2OR3)2 functional groups, wherein R3 is C1-C4 alkyl, preferably methyl.

The cross-linking agent may also be a modified melamine-formaldehyde type resin such as toluene sulfonamide modified melamine-formaldehyde resins, and the like.

In general, the cross-linking agent may be selected from compounds of the following formulae, wherein R3 is independently C1-C4 alkyl:

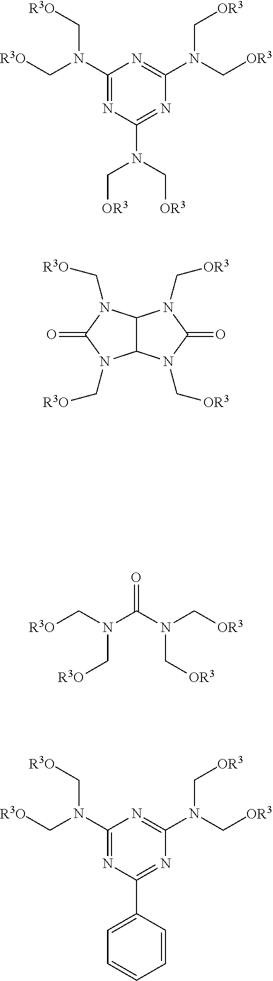

In this regard, preferred cross-linking agents include hexamethoxymethylmelamine, tetramethoxymethylbenzo-guanamine, tetramethoxymethylurea, mixed butoxy/methoxy substituted melamines, and the like. The most preferred cross-linking agent is hexamethoxymethylmelamine. Alternatively, a toluene sulfonamide methylated melaminformaldehyde resin powder may be utilized as a cross-linking agent.

The crosslinking agent may also be blocked or non-blocked isocyanate type of crosslinker. Examples of suitable isocyanate crosslinking agents include, but are not limited to, 1,6-hexamethylene diisocyanate, methylene bis (4-cyclohexyl isocyanate), isophorone diisocyanate, 2,4-toluene diisocyanate, Bayhydur® 302 (BAYER Material Science), the blocked trimer of isophorone diisocyanate (a food contact approved isocyanate) and Desmodur® BL 2078/2.

The crosslinking agent may also be phenolic resin type crosslinker. Examples of suitable phenolic crosslinking agents include the condensation products of phenols with aldehydes such as formaldehyde and acetaldehyde. Various phenols can be used such as phenol, cresol, p-alkylphenol, p-phenylphenol, and resorcinol. The phenolic resin may be resole or novolac type. Examples of suitable commercial phenolic resins include PHENODUR® PR 516/60B, PHENODUR® PR 371/70B, and PHENODUR® PR 612/80B available from Allnex; those with DUREZ 6 or VARCUM® trade names
available from Durex Corp.; and those with Bakelite® trade name available from MOMENTIVE.

The crosslinking agent many also be epoxidized phenolic resin type. An example is the reaction product of epichlorohydrin and phenol-formaldehyde novolac such as D.E.N.-431, -438, -439, or D.E.R. 354 available from Dow Chemical Company.

In the case of thermosetting powder coating compositions, preferred cross-linking agents include crosslinking compounds with epoxy groups such as triglycidyl isocyanurate. Preferred epoxy functional compounds generally have a molecular weight of about 300 to about 4000, and have approximately 0.05 to about 0.99 epoxy groups per 100 g of resin (i.e., 100-2000 weight per epoxy (WPE)). Such resins are widely known and are commercially available under EPON™ trade name available from MOMENTIVE.

In another aspect, this invention further provides a curable coating composition further comprising one or more cross-linking catalysts. Examples of such catalysts include p-toluenesulfonic acid, the NACURE™ 155, 5076, and 1051 catalysts sold by King Industries, BYK 450, 470, available from BYK-Chemie U.S.A., methyl tolyl sulfonimide, and the like.

As a further aspect of the present invention, there is provided a curable coating composition as described above, further comprising one or more leveling, rheology, and flow control agents such as silicones, fluorocarbons or cellulosics; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewcides; corrosion inhibitors; thickening agents; or coalescing agents.

Specific examples of such additives can be found in Raw Materials Index, published by the National Paint & Coatings Association, 1500 Rhode Island Avenue, N.W., Washington, D.C. 20005.

Isocyanates can be used as crosslinkers in accordance with the invention. Representative isocyanates include, but are not limited to, at least one compound chosen from toluene diisocyanate, diphenylmethane 4,4′-diisocyanate, methylenebis-4,4′-isocyanatocyclohexane, isophorone diisocyanate, 1,6-hexamethylene diisocyanate, 1,4-cyclohexane diisocyanate, p-phenylene diisocyanate, and triphenylmethane 4,4′,4″-triisocyanate, tetramethyl xylene diisocyanate, metaxylene diisocyanate, polyisocyanates, 1,4-butylene diisocyanate, methylene bis(4-cyclohexyl isocyanate), isophorone diisocyanate and isocyanate-terminated adducts of ethylene glycol, 1,4-butylene glycol, and trimethylol propane.

Phenolic and amino materials can also be used as crosslinkers. Suitable phenolics include phenolic resins derived from ortho, meta, para cresols along with phenol and can include other functionally substituted phenols. Examples of suitable phenolic materials that can be employed include phenol, cresol, p-phenylphenol, p-tertbutylphenol, p-tertamylphenol, cyclopentylphenol, cresylic acid, and combinations thereof. Suitable amino materials include melamine and benzoguamine and related resins.

The coating composition can also comprise isocyanate-terminated adducts of diols and polyols, such as ethylene glycol, 1,4-butylene glycol, trimethylol propane, etc., as crosslinkers. These crosslinkers are formed by reacting more than one mole of a diisocyanate, such as those mentioned, with one mole of a diol or polyol to form a higher molecular weight isocyanate prepolymer with a functionality of 2 to 3. Some commercial examples of isocyanate terminated adducts include isocyanate crosslinkers sold under the DESMODUR and MONDUR product lines by Covestro AG.

Examples of aliphatic isocyanates include 1, 6-hexamethylene diisocyanate, 1,4-butylene diisocyanate, methylene bis(4-cyclohexyl isocyanate), isophorone diisocyanate, and combinations thereof. Mixtures of isocyanate crosslinkers can also be employed.

Stoichiometric calculations for the curable polyester and isocyanate reaction are known to those skilled in the art and are described in The Chemistry of Polyurethane Coatings, Technical Publication p. 20, by Bayer Material Science, 2005. Persons having ordinary skill in the art will understand that crosslinking between the polyester resin and isocyanate reaches maximum molecular weight and optimal properties associated with molecular weight at an isocyanate:hydroxyl ratio of about 1:1; that is, when one equivalent of isocyanate (—NCO) reacts with one equivalent of hydroxyl (—OH). Typically, however, a small excess of isocyanate, about 5-10%, is used to allow for the loss of isocyanate by the reaction with adventitious moisture from the atmosphere, solvents, and pigments. Other NCO:OH ratios can be used; for example, it may be desirable to vary the NCO to OH ratio to less than 1:1 to improve flexibility or greater than 1:1 to produce harder, more chemical resistant coatings.

For the present invention, the solvent borne thermosetting coating composition has an NCO:OH ratio of from about 0.9:1.0 to about 1.5:1.0. Examples of other NCO:OH ratios are about 0.95:1. 0 to about 1.25:1.0 and about 0.95:1.0 to about 1.1:1.0.

The thermosetting coating composition also comprises about 0 to about 70 weight percent of at least one solvent, based on the total weight of the curable polyester, isocyanate, and the solvent. Examples of solvents include, but are not limited to, benzene, xylene, mineral spirits, naphtha, toluene, acetone, methyl ethyl ketone, methyl n-amyl ketone, methyl isoamyl ketone, n-butyl acetate, isobutyl acetate, t-butyl acetate, n-propyl acetate, isopropyl acetate, ethyl acetate, methyl acetate, ethanol, n-propanol, isopropanol, n-butanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol monoisobutyrate, ethylene glycol mono-octyl ether, diacetone alcohol, 2,2,4-trimethyl-1,3-pentanediol monoisobutyrate (available commercially from Eastman Chemical Co. under the trademark TEXANOL), AROMATIC 100 (C9-10 dialkyl and trialkylbenzenes), AROMATIC 150 (C10 aromatics, >1% naphthalene) or AROMATIC 200 (C10-13 aromatics, >1% naphthalene) available commercially from Exxon Mobile Corporation or combinations thereof. Typically, the coating composition of this invention will comprise about 30 to about 90 weight percent solids (i.e., non-volatiles), based on the total weight of the coating composition. Some additional examples of weight percent solids for the coating composition of the invention are 50, 60, 65, 70, 75, 80, and 85 weight percent.

In another embodiment, the curable aromatic polyester can comprise hydroxyl-terminated end groups and the crosslinker can comprise at least one isocyanate and a crosslinking catalyst.

Examples of isocyanate crosslinking catalysts include FASCAT 4102 (monobutyltin tris(2-ethylhexanoate)), FASCAT 4100 (monobutyltin oxide) both available from PMC Organoletallix, DABCOR T-12 (dibutyltin dilaurate) available from Air Products and K-KAT 348 (bismuth carboxylate catalyst), K-KAT 4205 (zirconium chelate complex), K-KAT 5218 (aluminum chelate complex), K-KAT XC-6212TH (zirconium chelate complex) non-tin catalysts available from King Industries and tertiary amines such as trialkylamines, for example triethylene amine, triethylene diamine and the like.

### EXAMPLES

This invention can be further illustrated by the following examples thereof, although it will be understood that these examples are included merely for purposes of illustration and are not intended to limit the scope of the invention unless otherwise specifically indicated.

### Abbreviations

mL is milliliter; wt % is weight percent; eq is equivalent(s); hrs or h is hour(s); mm is millimeter; m is meter; ° C. is degree Celsius; min is minute; g is gram; mmol is millimole; mol is mole; kg is kilogram; L is liter; w/v is weight/volume; μL is microliter; and MW is molecular weight.

### Example 1: Preparation of Unsaturated Polyester (UPE) Resin (Resin 1)

This example describes the preparation of an unsaturated polyester resin with about 25% of unsaturation using phthalic anhydride (PA)/maleic anhydride (MAH) as the major diacid components and neopentyl glycol (NPG) as the major diol components.

The UPE resin was produced using a resin kettle reactor controlled with automated control software. The compositions were produced using a 2 L glass kettle with overhead mechanical stirring and a partial condenser topped with total condenser and Dean Stark trap. Neopentyl glycol (NPG, 473.88 grams, 4.550 moles), phthalic anhydride (PA, 320.93 grams, 2.167 moles), and maleic anhydride (MAH, 212.47 grams, 2.167 moles) were added to the reactor which was then completely assembled. Butyltin tris(2-ethylhexanoate) (FASCAT 4102 available commercially from PMC Organometallix, Inc., 2.06 grams) and the inhibitor (4-methoxyphenol, MeHQ, 1.06 grams) were added via the sampling port after the reactor had been assembled and blanketed with nitrogen for the reaction. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 210° C. over the course of 2 hours. The reaction was held at 210° C. for 3 hours. The resultant UPE resin has a fumarate/maleate ratio of 79/21.

### Example 2: Preparation of UPE Resin 2

This example describes the preparation of an unsaturated polyester resin with about 15% of unsaturation using isophthalic acid (IPA)/maleic anhydride (MAH) as the major diacid components and 2-methyl-1,3-propanediol (MPD) as the major diol components.

The UPE resin was produced using a resin kettle reactor setup controlled with automated control software. The compositions were produced using a 2 L glass kettle with overhead mechanical stirring and a partial condenser topped with total condenser and Dean Stark trap. 2-Methyl-1,3-propanediol (MPD, 410.05 grams, 4.550 moles), isophthalic acid (IPA, 503.94 grams, 3.033 moles), and maleic anhydride (MAH, 127.48 grams, 1.300 moles) were added to the reactor which was then completely assembled. Butyltin tris(2-ethylhexanoate) (FASCAT 4102 available commercially from PMC Organometallix, Inc., 2.13 grams) and the inhibitor (4-methoxyphenol, MeHQ, 0.64 grams) were added via the sampling port after the reactor had been assembled and blanketed with nitrogen for the reaction. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 210° C. over the course of 2 hours. The reaction was held at 210° C. for 3 hours. The resultant UPE resin has a fumarate/maleate ratio of 73/27.

### Example 3: Preparation of UPE Resin 3

This example describes the preparation of an unsaturated polyester resin with about 25% of unsaturation using isophthalic acid (IPA)/maleic anhydride (MAH) as the major diacid components and 2,2,4,4-tetramethylcyclobutanediol (TMCD)/neopentyl glycol (NPG) as the major diol components.

The UPE resin was produced using a resin kettle reactor setup controlled with automated control software. The compositions were produced using a 2 L glass kettle with overhead mechanical stirring and a partial condenser topped with total condenser and Dean Stark trap. 2,2,4,4-Tetramethylcyclobutanediol (TMCD, 70.66 grams, 0.490 moles), neopentyl glycol (NPG, 459.30 grams, 4.410 moles), and isophthalic acid (IPA, 387.64 grams, 2.333 moles) were added to the reactor which was then completely assembled. Butyltin tris(2-ethylhexanoate) (FASCAT 4102 available commercially from PMC Organometallix, Inc., 2.34 grams) was added via the sampling port after the reactor had been assembled and blanketed with nitrogen for the reaction. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 230° C. over the course of 2.5 hours. The reaction was held at 230° C. for 1 hour and then cooled down to 160° C. and the second-stage reactants, the inhibitor (4-methoxyphenol, MeHQ, 1.144 grams) and maleic anhydride (MAH, 228.81 grams, 2.333 moles) were added. The reaction was ramped to 230° C. over the course of 0.5 hour, and then held at 230° C. for 2 hours. The reaction was held at 210° C. for 3 hours. The resultant unsaturated polyester resin has a fumarate/maleate ratio of 91/9.

### Example 4: Preparation of UPE Resin 4

This example describes the preparation of an unsaturated polyester resin with about 15% of unsaturation using isophthalic acid (IPA)/maleic anhydride (MAH) as the major diacid components and 2,2,4,4-tetramethylcyclobutanediol (TMCD)/2-methyl-1,3-propanediol (MPD) as the major diol components.

The UPE resin was produced using a resin kettle reactor setup controlled with automated control software. The compositions were produced using a 2 L glass kettle with overhead mechanical stirring and a partial condenser topped with total condenser and Dean Stark trap. 2,2,4,4-Tetramethylcyclobutanediol (TMCD, 131.23 grams, 0.910 moles), 2-methyl-1,3-propanediol (MPD, 328.04 grams, 3.640 moles), isophthalic acid (IPA, 503.94 grams, 3.033 moles), and maleic anhydride (MAH, 127.48 grams, 1.300 moles) were added to the reactor which was then completely assembled. Butyltin tris(2-ethylhexanoate) (FASCAT 4102 available commercially from PMC Organometallix, Inc., 2.23 grams) and the inhibitor (4-methoxyphenol, MeHQ, 0.64 grams) were added via the sampling port after the reactor had been assembled and blanketed with nitrogen for the reaction. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 210° C. over the course of 3 hours. The reaction was held at 210° C. for 3 hours. The resultant unsaturated polyester resin has a fumarate/maleate ratio of 74/26.

### Example 5: Preparation of UPE Resin 5

This example describes the preparation of an unsaturated polyester resin with about 2.5% of unsaturation using phthalic anhydride (PA) as the major diacid components and neopentyl glycol (NPG)/maleic anhydride (MAH) as the major diacid components.

The unsaturated polyester resin was produced using a resin kettle reactor setup controlled with automated control software. The compositions were produced using a 2 L glass kettle with overhead mechanical stirring and a partial condenser topped with total condenser and Dean Stark trap. Neopentyl glycol (NPG, 473.88 grams, 4.550 moles), phthalic anhydride (PA, 609.77 grams, 4.117 moles), and maleic anhydride (MAH, 21.25 grams, 0.217 moles) were added to the reactor which was then completely assembled. Butyltin tris(2-ethylhexanoate) (FASCAT 4102 available commercially from PMC Organometallix, Inc., 2.26 grams) and the inhibitor (4-methoxyphenol, MeHQ, 0.21 grams) were added via the sampling port after the reactor had been assembled and blanketed with nitrogen for the reaction. The reaction mixture was heated without stirring from room temperature to 150° C. using a set output controlled through the automation system. Once the reaction mixture was fluid enough, stirring was started to encourage even heating of the mixture. At 150° C., the control of heating was switched to automated control and the temperature was ramped to 210° C. over the course of 2 hours. The reaction was held at 210° C. for 4 hours. The resultant unsaturated polyester resin has a fumarate/maleate ratio of 88/12.

### Example 6: Analytical Test of Fumarate/Maleate Ratio in Unsaturated Polyester Resins

The fumarate/maleate ratio was determined by the ratio of the integrals of the proton peaks at 6.9 ppm for fumarate and 6.2 ppm for maleate in the ¹H NMR spectrum of the resin using deuterated chloroform as the NMR solvent. Bruker 500 MHz spectrometer for data collection. The relative content of fumarate in the isomers (Fumarate %) is expressed as the integral of fumarate (at 6.9 ppm) divided by the sum of both the integrals of fumarate (at 6.9 ppm) and maleate (at 6.2 ppm).

### Example 7: Treatment of UPE Resins with Isomerization Catalyst DMAA

To a three-neck round bottom flask equipped with a mechanical stirrer and a water condenser was charged with 100 g of the unsaturated polyester resin, Resin 1. The resin was heated to 180° C. and stirred under nitrogen atmosphere. The isomerization catalyst, DMAA (2.3 grams, 0.0175 mol) was added to the flask. The mixture was heat at to 180° C. and stirred under nitrogen atmosphere. After one hour, the flask was cooled down and the resin was analyzed by ¹H NMR for the fumarate/maleate ratio. The results are shown in Table 1.

### Example 8: Treatment of UPE Resins with Other Compounds with Similar Structures to DMAA

To a three-neck round bottom flask equipped with a mechanical stirrer and a water condenser was charged with 100 g of the unsaturated polyester resin, Resin 1. The resin was heated to 180° C. and stirred under nitrogen atmosphere. The isomerization compound (0.0175 mol) was added to the flask. The isomerization compounds include N,N-Diethylacetoacetamide, N,N-Dimethylformamide, N-(tert-Octyl)acetoacetamide, N-Methyl-3-oxo-N-phenylbutanamide, Urea, N,N-Dimethyl-2-chloroacetoacetamide, Acetoacetanilide, Acetamide, Ethylenediamine-N,N′-bis(acetoacetamide), N,N-Dimethylacetamide, Acetoacetamide, Methyl acetoacetate, N-methylacetoacetamide, Methyl carbamate, Dimethyl malonate, 1-Methylpiperidine-2,4-dione. The mixture was heat at to 180° C. and stirred under nitrogen atmosphere. After one hour, the flask was cooled down and the resin was analyzed by ¹H NMR for the fumarate/maleate ratio. The results are shown in Table 1.

TABLE 1
The relative fumarate contents of Resin 1 (initial Fumarate % = 79%)
after being heated at 180° C. for 1 hour with various compounds.

| | | Fumarate/ | |
|---|---|---|---|
| | | Maleate | Fumarate |
| Entry | Compound | ratio | % |
| 1 | N,N-Dimethylacetoacetamide | 28.2 | 97% |
| 2 | N,N-Diethylacetoacetamide | 6.32 | 86% |
| 3 | N,N-Dimethylformamide | 6.12 | 86% |
| 4 | N-(tert-Octyl)acetoacetamide | 4.41 | 82% |
| 5 | N-Methyl-3-oxo-N- | 4.42 | 82% |
| | phenylbutanamide | | |
| 6 | Urea | 4.43 | 82% |
| 7 | N,N-Dimethyl-2- | 4.27 | 81% |
| | chloroacetoacetamide | | |
| 8 | Acetoacetanilide | 4.40 | 81% |
| 9 | Acetamide | 4.08 | 81% |
| 10 | Ethylenediamine-N,N′- | 4.01 | 80% |
| | bis(acetoacetamide) | | |
| 11 | N,N-Dimethylacetamide | 4.10 | 80% |
| 12 | Acetoacetamide | 4.17 | 80% |
| 13 | Methyl acetoacetate | 3.90 | 80% |
| 14 | N-methylacetoacetamide | 4.08 | 80% |
| 15 | Methyl carbamate | 3.79 | 79% |
| 16 | Dimethyl malonate | 3.79 | 79% |
| 17 | 1-Methylpiperidine-2,4-dione | 3.84 | 79% |

### Example 9: Treatment of UPE Resins with Isomerization Catalyst DMAA at Various Catalyst Loadings

To a three-neck round bottom flask equipped with a mechanical stirrer and a water condenser was charged with 100 g of the unsaturated polyester resin, Resin 1. The resin was heated to 180° C. and stirred under nitrogen atmosphere. The isomerization catalyst, DMAA (0.3 wt %, 1.1 wt %, or 2.3 wt % of the resin) was added to the flask. The mixture was heat at to 180° C. and stirred under nitrogen atmosphere. After 15 minutes, a resin sample was taken by a glass pipet from the flask and analyzed by ¹H NMR for the fumarate/maleate ratio. After one hour, the flask was cooled down and the resin was analyzed by ¹H NMR for the fumarate/maleate ratio.

TABLE 2
The relative fumarate contents of Resin 1 (initial Fumarate % =
79%) after being heated at 180° C. for 15 minutes and 1 hour at
various DMAA contents (0.3 wt %, 1.1 wt %, and 2.3 wt %).

| Entry | DMAA content | 0 minute | 15 minutes | 60 minutes |
|---|---|---|---|---|
| 1 | 0.3% | 79% | 84% | 87% |
| 2 | 1.1% | 79% | 90% | 96% |
| 3 | 2.3% | 79% | 96% | 98% |

### Example 10: Treatment of UPE Resins with Isomerization Catalyst DMAA at Various Temperatures

To an aluminum pan was charged with 10 g of the unsaturated polyester resin, Resin 1. A resin solution in DPM with 50% by weight was used for experiments at 50 and 100° C. A neat resin without solvent was used for experiments at 150 and 180° C. The resin was placed in an oven and heated to desired temperature (50, 100, 150, or 180° C.) under nitrogen atmosphere. The isomerization catalyst, DMAA (2.3 wt % of the resin) was added to the resin and stirred for 1 minutes. The mixture was heated at the same temperature under nitrogen atmosphere. After one hour, the resin was cooled down and the resin was analyzed by ¹H NMR for the fumarate/maleate ratio.

TABLE 3
The relative fumarate contents of Resin 1 (initial Fumarate % = 79%)
after being heated at various temperatures (50, 100, 150,
and 180° C.) for 1 hour with 2.3 wt % DMAA.

| Entry | Temperature (° C.) | Fumarate % |
|---|---|---|
| 1 | 50 | 79% |
| 2 | 100 | 80% |
| 3 | 150 | 83% |
| 4 | 180 | 97% |

### Example 11: Treatment of UPE Resins with Isomerization Catalyst DMAA at 100° C. with Various Catalyst Loadings

To a three-neck round bottom flask equipped with a mechanical stirrer and a water condenser was charged with 100 g of the unsaturated polyester resin, Resin 1. The resin was heated to 100° C. and stirred under nitrogen atmosphere. The isomerization catalyst, DMAA (2.3 or 11.3 wt % of the resin) was added to the flask. The mixture was heat at to 100° C. and stirred under nitrogen atmosphere. After 15 minutes, a resin sample was taken by a glass pipet from the flask and analyzed by ¹H NMR for the fumarate/maleate ratio. After one hour, the flask was cooled down and the resin was analyzed by ¹H NMR for the fumarate/maleate ratio.

TABLE 4
The relative fumarate contents of Resin 1 (initial Fumarate % = 79%)
after being heated at 100° C.) for 1, 8, and 24 hours with DMAA.

| | DMAA | | | | |
|---|---|---|---|---|---|
| Entry | content | 0 hour | 1 hour | 8 hours | 24 hours |
| 1 | 2.3% | 79% | 80% | 89% | 98% |
| 2 | 11.3% | 79% | 84% | 98% | 99% |

### Example 12: Treatment of UPE Resin 2 with Isomerization Catalyst DMAA

To a three-neck round bottom flask equipped with a mechanical stirrer and a water condenser was charged with 100 g of the unsaturated polyester resin, Resin 2. The resin was heated to 180° C. and stirred under nitrogen atmosphere. The isomerization catalyst, DMAA (0.5, 1.4 or 2.3 wt % of the resin) was added to the flask. The mixture was heat at to 180° C. and stirred under nitrogen atmosphere. After one hour, the flask was cooled down and the resin was analyzed by ¹H NMR for the fumarate/maleate ratio.

TABLE 5
The relative fumarate contents of Resin 2 (initial Fumarate % =
73%) after being heated at 180° C. for 1 hour with DMAA.

| | DMAA | Fumarate/ | |
|---|---|---|---|
| Entry | content | Maleate ratio | Fumarate % |
| 1 | 0% | 2.69 | 73% |
| 2 | 0.5% | 19.40 | 95% |
| 3 | 1.4% | 27.21 | 96% |
| 4 | 2.3% | 31.26 | 97% |

### Example 13: Treatment of UPE Resin 3 with Isomerization Catalyst DMAA

To a three-neck round bottom flask equipped with a mechanical stirrer and a water condenser was charged with 100 g of the unsaturated polyester resin, Resin 3. The resin was heated to 180° C. and stirred under nitrogen atmosphere. The isomerization catalyst, DMAA (0.5, 1.1 or 2.3 wt % of the resin) was added to the flask. The mixture was heat at to 180° C. and stirred under nitrogen atmosphere. After one hour, the flask was cooled down and the resin was analyzed by ¹H NMR for the fumarate/maleate ratio.

TABLE 6
The relative fumarate contents of Resin 3
(initial Fumarate % = 91%) after
being heated at 180° C. for 1 hour with 1DMAA.

| | DMAA | Fumarate/ | |
|---|---|---|---|
| Entry | content | Maleate ratio | Fumarate % |
| 1 | 0% | 9.64 | 91% |
| 2 | 0.5% | 34.03 | 97% |
| 3 | 1.1% | 27.35 | 96% |
| 4 | 2.3% | 33.92 | 97% |

### Example 14: Treatment of UPE Resin 4 with Isomerization Catalyst DMAA

To a three-neck round bottom flask equipped with a mechanical stirrer and a water condenser was charged with 100 g of the unsaturated polyester resin, Resin 4. The resin was heated to 180° C. and stirred under nitrogen atmosphere. The isomerization catalyst, DMAA (1.4 or 2.3 wt % of the resin) was added to the flask. The mixture was heat at to 180° C. and stirred under nitrogen atmosphere. After one hour, the flask was cooled down and the resin was analyzed by ¹H NMR for the fumarate/maleate ratio.

TABLE 7
The relative fumarate contents of Resin 4
(initial Fumarate % = 74%)
after being heated at 180° C. for 1 hour with DMAA.

| | DMAA | Fumarate/ | |
|---|---|---|---|
| Entry | content | Maleate ratio | Fumarate % |
| 1 | 0% | 2.90 | 74% |
| 2 | 0.5% | 25.76 | 96% |
| 3 | 1.4% | 18.42 | 95% |
| 4 | 2.3% | 24.05 | 96% |

### Example 15: Treatment of UPE Resin 5 with Isomerization Catalyst DMAA

To a three-neck round bottom flask equipped with a mechanical stirrer and a water condenser was charged with 100 g of the unsaturated polyester resin, resin 5. the resin was heated to 180° c. and stirred under nitrogen atmosphere. The isomerization catalyst, DMAA (0.23, 0.5, or 2.3 wt % of the resin) was added to the flask. The mixture was heat at to 180° C. and stirred under nitrogen atmosphere. After one hour, the flask was cooled down and the resin was analyzed by H NMR for the fumarate/maleate ratio.

TABLE 8
The relative fumarate contents of Resin 5 (initial Fumarate % =
88%) after being heated at 180° C. for 1 hour with DMAA.

| | DMAA | Fumarate/ | |
|---|---|---|---|
| Entry | content | Maleate ratio | Fumarate % |
| 1 | 0% | 7.10 | 88% |
| 2 | 0.23% | 16.67 | 94% |
| 3 | 0.5% | 16.51 | 95% |
| 4 | 2.3% | 33.29 | 97% |

The invention has been described in detail with reference to the embodiments disclosed herein, but it will be understood that variations and modifications can be effected within the spirit and scope of the invention.

1. A process for the preparation of an unsaturated polyester resin comprising:
(a) synthesizing an unsaturated polyester resin having maleate isomer content by reacting a polyacid component and a polyol component, in the presence of a catalyst, wherein at least one of said polyacid and said polyol components is an ethylenically unsaturated compound; and
(b) converting maleate isomer to fumarate isomer in the unsaturated polyester resin of step a) by catalytic isomerization with N,N-dimethylacetoacetamide to a fumarate/maleate ratio of 90/10 or greater fumarate.

2. The process according to claim 1 wherein the ethylenically unsaturated compound comprises one or more of the following: maleic anhydride/acid, dialkyl maleate, monoalkyl maleate, citraconic anhydride/acid, 2,3-dimethylmaleic anhydride/acid, 2-tert-butylmaleic anhydride/acid, phenylmaleic anhydride/acid.

3. The process according to claim 1 wherein the polyacid component of step (a) comprises one or more of the following: isophthalic acid (or dimethyl isophthalate), terephthalic acid (or dimethyl terephthalate), phthalic acid, phthalic anhydride, 1,4-cyclohexanedicarboxylic acid, 1,3-cyclohexanedicarboxylic acid, hexahydrophthalic anhydride, tetrahydrophthalic anhydride, tetrachlorophthalic anhydride, dodecanedioic acid, sebacic acid, azelaic acid, maleic acid or anhydride, fumaric acid, succinic anhydride, succinic acid, adipic acid, 2,6-naphthalenedicarboxylic acid, glutaric acid, itaconic acid, and their derivatives, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, nadic acid, hexahydrophthalic acid, 2,5-bis(hydroxymethyl)furan, 2,5-furandicarboxylic acid.

4. The process according to claim 1 wherein the polyol component of step (a) comprises one or more of the following: 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 1,7-heptanediol, 1,8-octanediol, 1,9-nonanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, polyethylene glycol, 1,1,1-trimethylol propane, 1,1,1-trimethylolethane, glycerin, pentaerythritol, erythritol, threitol, dipentaerythritol, sorbitol, glycerol, trimethylolethane, trimethylolpropane, pentaerythritol, 1,2,6-hexanetriol, 1,1,4,4-tetrakis(hydroxymethyl)cyclohexane, tris(hydroxyethyl)isocyanurate, tripentaerythritol, and dipentaerythritol, tripropylene glycol, hexylene glycol, 1,2-propanediol, 1,3-propanediol, butyl ethyl propanediol, 2-ethyl-1,4-butanediol, trimethyl pentanediol, 2-methylpentanediol, trimethylol butane, tricyclodecane dimethanol, 2-ethyl-2,4-dimethylhexane-1,3-diol, p-xylenediol, hydrogenated bisphenol A, bio-mass derived polyols, and oligomer molecules having a hydroxyl group at each end resulting from an alcoholysis reaction of collected waste polyethylene terephthalate by an aliphatic glycol.

5. The process according to claim 1 wherein step (a) is conducted under polycondensation conditions at a temperature of about 150 to 260° C.

6. The process according to claim 1 wherein said catalyst of step (a) is a polycondensation catalyst in a concentration of about 0.01 to 1.00 weight percent, based on the amount of reactants.

7. The process according to claim 1 wherein said N,N-dimethylacetoacetamide catalyst of step (b) comprises one or more of N,N-dimethylacetoacetamide without solvent, N,N-dimethylacetoacetamide in an aqueous solution, and N,N-dimethylacetoacetamide solution in an organic solvent.

8. The process according to claim 1 wherein the N,N-dimethylacetoacetamide aqueous solution has a N,N-dimethylacetoacetamide weight content above 1%.

9. The process according to claim 1 wherein the N,N-dimethylacetoacetamide solution in organic solvent has a N,N-dimethylacetoacetamide weight content above 1%.

10. The process according to claim 1 wherein the amount of the added dimethylacetoacetamide catalyst in step (b) ranges from 0.01 to 1000 parts by weight.

11. The process according to claim 1 wherein the temperature for the isomerization in step (b) ranges from 50 to 250° C.

12. The process according to claim 1 wherein the isomerization in step (b) is conducted for a period of 5 minutes to 120 hours.

13. A curable coating composition comprising:
(a) an unsaturated polyester having a fumarate/maleate ratio of 90/10 or greater; and
(b) a crosslinker selected from the group comprising amino resin, blocked isocyanate resin, phenolic resins, epoxy resin, and epoxidized phenolic resin.

14. An unsaturated polyester comprising:
(a) the residues of maleic anhydride in an amount ranging from about 0.5 to 90 mole %, based on the total moles of (a) and (b),
(b) a polycarboxylic acid compound, a derivative of polycarboxylic acid compound other than maleic anhydride, or a combination thereof comprising;
(i) a polycarboxylic acid in an amount ranging from 10 to 99.5 mole %, based on the total moles of (bi) and (bii), and
(ii) a polycarboxylic acid anhydride in an amount ranging from 0 to 99.5 mole %, based on the total moles of (bi) and (bii), and
(c) a polyhydroxyl component comprising:
(i) a diol in an amount ranging from 0 to 95 mole %, based on the total moles of (ci) and (cii), and
(ii) a triol or tetraol in an amount ranging from 0 to 20 mole %, based on the total moles of (a) and (b); and
wherein said unsaturated polyester has a fumarate/maleate ratio of 90/10 or greater.

15. (canceled)
